(19) United States
(12) Patent Application Publication
(10) Pub. No.: US 2014/0088474 A1
(43) Pub. Date: Mar. 27, 2014

(54) FOLDABLE AND EXPANDABLE PRESSURE POINT MAT

(71) Applicants: Galina Bukharina, Austin, TX (US); Nathali Parker, Round Rock, TX (US); Roger Borbon, Spicewood, TX (US)

(72) Inventors: Galina Bukharina, Austin, TX (US); Nathali Parker, Round Rock, TX (US); Roger Borbon, Spicewood, TX (US)

(21) Appl. No.: 13/626,283

(22) Filed: Sep. 25, 2012

(51) Int. Cl. A61H 7/00

(52) U.S. Cl. 601/134

(57) ABSTRACT

A mat section can be connected to one or more additional mat sections to provide a desired size combination of the mat sections. One mat section can be interconnected with an adjacent mat section by use of a flexible hinge member such that the adjacent mat sections can be folded together and stacked into engagement by folding the hinge. Each mat section includes an array of pressure point fingers.

### BACKGROUND

Pressure point devices have been used to apply pressure to targeted areas of human tissue to relieve pain and provide therapeutic treatment by applying multiple pressure points to a given area of a body, such as a human body, without penetrating or harming the tissue. As a result, blood flow is increased to the pressure area thus stimulating a natural healing effect. The multiple pressure points can be provided as protrusions on a supporting mat. The protrusions can be in the form of a selected array of fingers formed of a suitable material. Such devices could also be used to provide therapeutic treatment to animals.

The mat can be of a size suitable to contact an area or a portion of the treated body, and several such mats can be used to provide an enlarged area. If the mat is of a relatively large size for contacting a large area of the body, that size may be inconvenient for carrying. If the mat is of a relatively small size, additional mats may be required to engage a targeted treatment area.

Accordingly, it would be advantageous to provide a mat which is of a size suitable to be expanded by joining with additional mats, and to be able to join multiple mats by means of a flexible connector which permits one of the mats to be folded into a stacked engagement with an adjacent one of the mats.

### SUMMARY

One embodiment accordingly, provides a mat section which can be connected to one or more additional mat sections to provide a desired size combination of the mat sections. One mat section can be interconnected with an adjacent mat section by use of a flexible hinge member such that the adjacent mat sections can be folded together and stacked into engagement by folding the hinge. Each mat section includes an array of pressure point fingers.

### BRIEF DESCRIPTION OF THE DRAWINGS

FIG. 1 is a perspective view illustrating an embodiment of one side of a pressure point mat.

FIG. 2 is a perspective view illustrating an embodiment of another side of the mat of FIG. 1.

FIG. 2A is an enlarged view of a portion of the mat of FIG. 2.

FIGS. 3-5 are end views illustrating embodiments of side-by-side pairs of mats.

FIGS. 6 and 7 are planar and end views, respectively illustrating an embodiment of a flexible hinge.

FIG. 8 is an end view illustrating an embodiment of the mats of FIGS. 3-5 in a stacked position.

FIG. 8A is an enlarged view of a portion of the stacked mats of FIG. 8.

### DETAILED DESCRIPTION

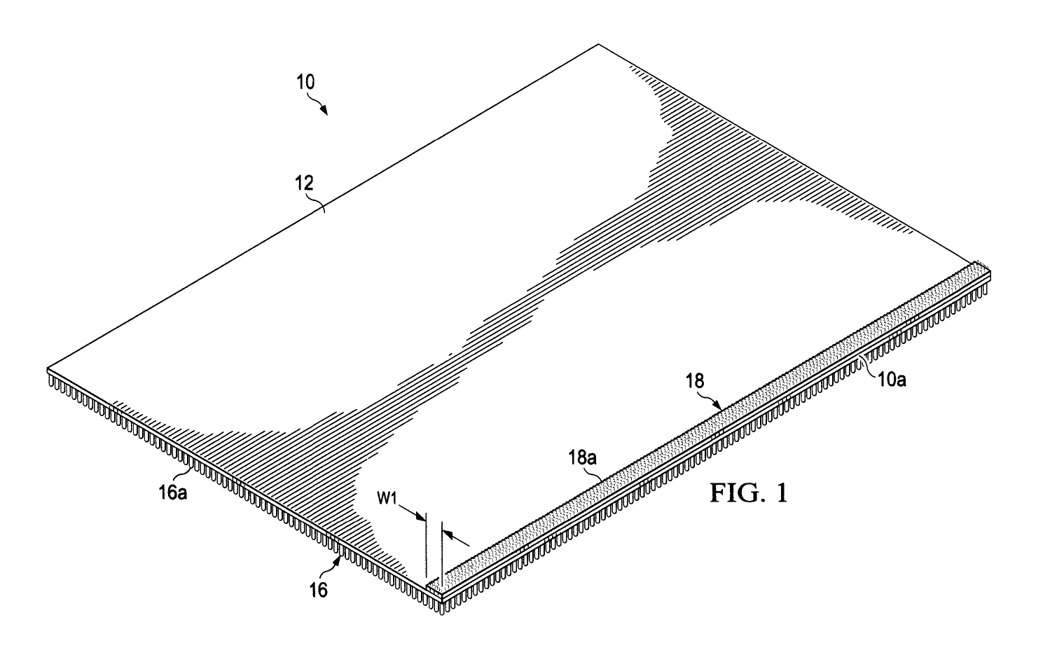

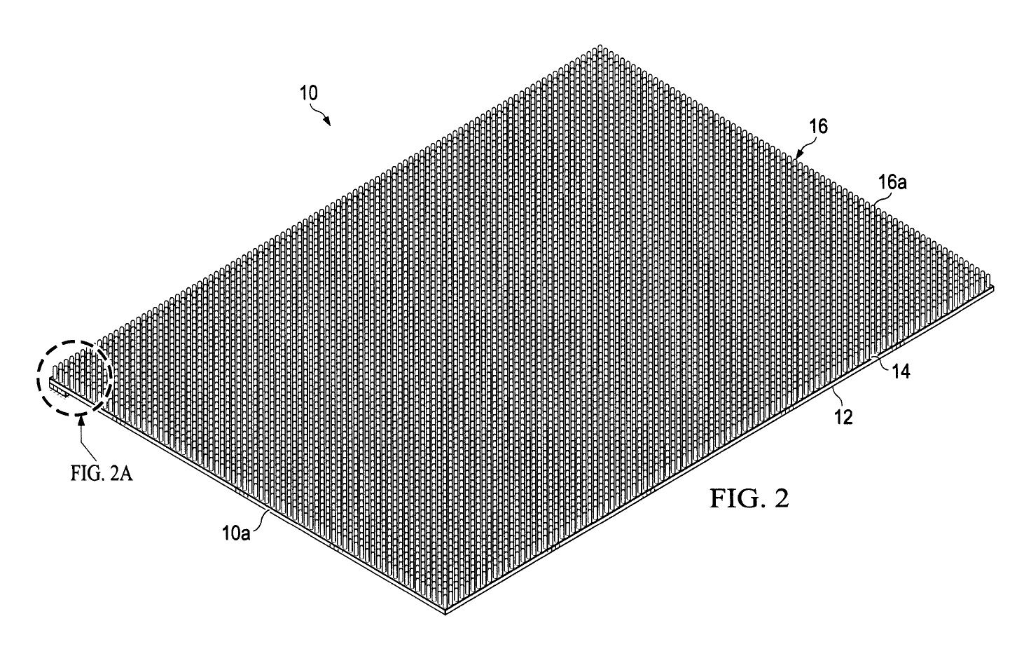

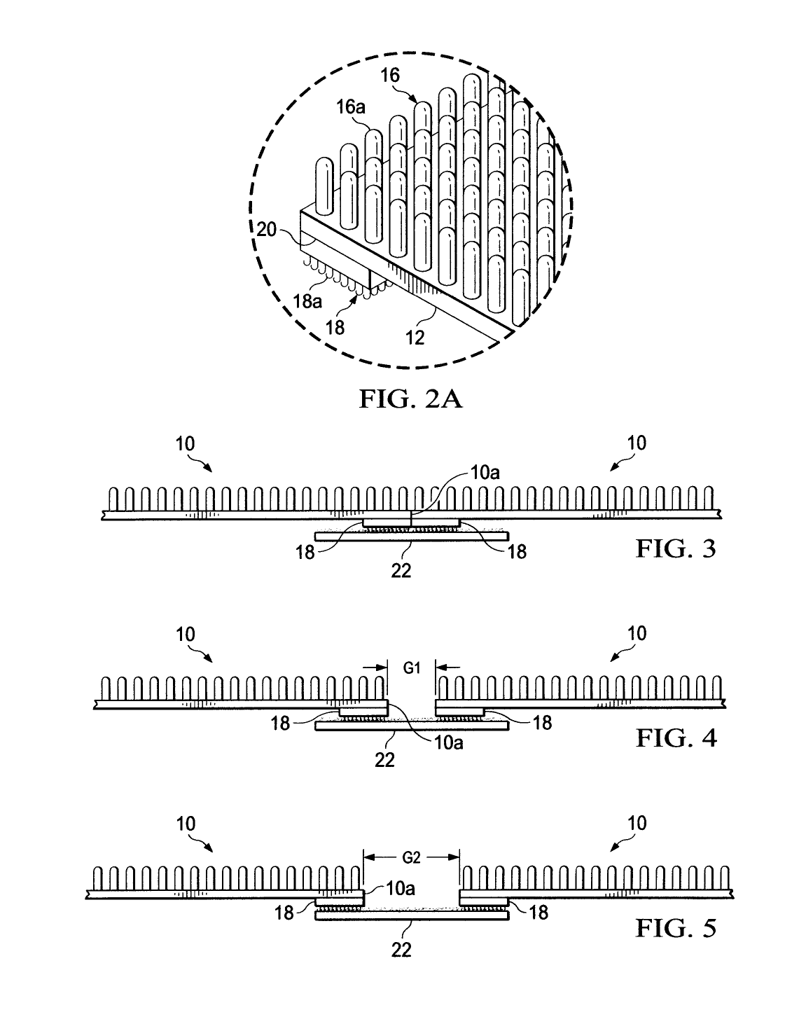

A therapeutic device includes a mat 10 having a first planar surface 12, FIGS. 1 and 2, and a second surface 14 opposite the first surface 12. A plurality of pressure point fingers 16 extend from the second surface 14 in a substantially dense array. The mat 10 and the pressure point fingers 16 are formed of a suitable synthetic material. The mat 10 and the fingers 16 are flexible and there is sufficient spacing between the fingers to allow the fingers to flex when a force is applied to a terminal or free end 16a of the fingers 16.

The mat 10 is substantially rectangular but can be of any suitable size or shape. One or more peripheral edges 10a of the mat 10 can include a first connector such as a strip 18 extending along and connected to the first planar surface 12 such as by an adhesive 20, see also FIG. 2A. A hook and loop connector system may be used and include a commercially available Velcro® hook and loop fastening device. As such, a connector surface 18a of the strip 18 can be of either a hook or loop connector.

A single mat 10 can be used to treat a specific area of a user's body, such as a back and shoulder region of an upper torso. If one mat 10 is insufficient to treat the desired area, a plurality of identical mats 10, FIGS. 3-5, can be combined and positioned, side-by-side, and in addition, the side-by-side mats 10 can be adjustably positioned. In this manner, a larger portion of a user's body can be treated by the expanded mat combination. When positioned side-by-side, the mats 10 will have their respective first connector strips 18 also positioned side-by-side.

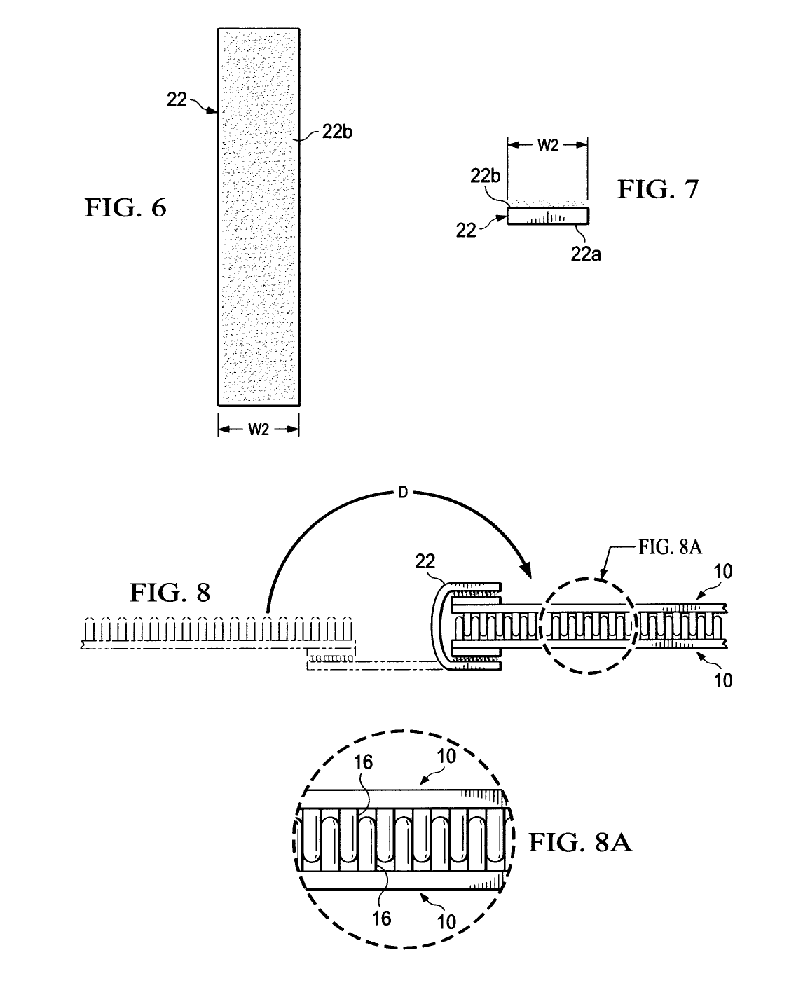

In order to stabilize the side-by-side mats 10 from inadvertent movement, a second flexible connector 22 can be used, see also FIGS. 6 and 7. The second connector 22 can include a smooth surface 22a and the other of a hook or loop connector surface 22b to permit mating connection with the side-by-side first connector strips 18. The strips 18 or first connectors, described above are each of a first width W1, FIG. 1. The second connector 22 is a strip of a second width W2, FIGS. 6, 7, wider than the sum of the first widths W1, and in fact is preferably three to four times the width of the sum of the widths of the side-by-side strips 18. The first smooth surface 22a is opposite the second connector surface 22b.

Referring again to FIGS. 3, 4, and 5, a pair of side-by-side mats 10 are illustrated. In FIG. 3, the mats 10 are positioned in abutment at the peripheral edges 10a along which the first connector strips 18 extend. Such positioning avoids a gap between the fingers 16 of the adjacent mats. In FIG. 4, there is a gap having a width G1 and in FIG. 5, there is a gap having a width G2, greater than the width G1. The adjacent mats 10 in FIGS. 3-5 are maintained in their respective positions due to the second connector strip 22 being matingly engaged with the first connector strips 18. Because of the difference in width between the first and second connector strips 18, 22, respectively, the adjacent mats 10 can be adjustably positioned between an abutment position FIG. 3, a first gap G1 position FIG. 4, and a second gap G2 position FIG. 5.

FIG. 8 illustrates that with the adjacent mats 10 being positioned with a gap, for example, a gap having the width G2, the flexible connector 22 can be folded in such a manner that the adjacent mats 10, can be stacked. In FIG. 8 one of the mats 10 is rotated about 180° as indicated by a directional arrow designated D. When stacked, the pressure point fingers 16 of one of the mats 10 can become intermeshed with the pressure point fingers 16 of the other of the mats 10. As a result, the overall thickness of the stacked mats, FIG. 8A, is reduced for convenience in transporting and storing the mats.

The foregoing has described a pressure point mat which may be used in a single mat configuration or in an expanded dual mat configuration. Additionally, the mats can be connected in adjustable side-by-side configurations and can be folded into a stack by means of a flexible hinge.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A therapeutic apparatus, comprising:
a plurality of adjacent mats each having an array of pressure point fingers extending from a surface of each mat;
a peripheral edge of each mat including first connectors, the peripheral edges being side-by-side;
a flexible hinge having mating second connectors, the mating second connectors being matingly engaged with the first connectors of the peripheral edge of each mat;
whereby, in an expanded mode, the mats are positioned side-by-side exposing the pressure point fingers of each adjacent mat; and
whereby, in a stacked mode, one mat is folded at the hinge and stacked on the adjacent mat intermeshing the pressure point fingers of the stacked mats.

2. The apparatus as defined in claim 1 wherein the flexible hinge is removably connected to the adjacent mats.

3. The apparatus as defined in claim 1 wherein the flexible hinge is adjustably connected to the adjacent mats.

4. The apparatus as defined in claim 2 wherein the flexible hinge is adjustably connected to the adjacent mats.

5. The apparatus as defined in claim 1 wherein the first connectors comprise a strip on each mat, each strip having a first width.

6. The apparatus as defined in claim 5 wherein the flexible hinge is of a second width greater than the first width.

7. The apparatus as defined in claim 5 wherein the flexible hinge is of a second width greater than the sum of the widths of the strips.

8. A therapeutic apparatus, comprising:
a plurality of mats each having an array of flexible pressure point fingers extending from a surface of each mat;
a peripheral edge of each mat including first connectors, the peripheral edge of a first one of the mats being adjacent a peripheral edge of a second one of the mats;
a flexible hinge having second connectors, different from the first connectors, the second connectors being matingly engaged with the first connectors;
the mats being positionable in a first position wherein the mats are side-by-side and the pressure point fingers of each mat are exposed; and
the mats being positionable in a second position having the first one of the mats folded at the hinge and stacked on the second one of the mats such that the pressure point fingers of the mats are intermeshed.

9. The apparatus as defined in claim 8 wherein the flexible hinge is removably connected to the adjacent mats.

10. The apparatus as defined in claim 8 wherein the flexible hinge is adjustably connected to the adjacent mats.

11. The apparatus as defined in claim 9 wherein the flexible hinge is adjustably connected to the adjacent mats.

12. The apparatus as defined in claim 8 wherein the first connectors comprise a strip on each mat, each strip having a first width.

13. The apparatus as defined in claim 12 wherein the flexible hinge is of a second width greater than the sum of the widths of the strips.

14. A method of providing a multi-positionable therapeutic device, comprising:
providing a plurality of adjacent mats, each mat having an array of pressure point fingers extending from a surface of each mat;
providing first connectors on adjacent peripheral edges of each mat;
positioning the adjacent mats side-by-side and exposing the pressure point fingers of each mat for use in an expanded mode;
connecting a flexible hinge having mating second connectors, the mating second connectors being matingly engaged with the first connectors of the adjacent peripheral edges of the mats; and
folding a first one of the adjacent mats at the hinge and rotating the first mat about 180° into a stacked position on a second one of the adjacent mats for intermeshing the pressure point fingers of the stacked mats for storage and portability.

15. The method as defined in claim 14 wherein the flexible hinge is removably connected to the adjacent mats.

16. The method as defined in claim 14 wherein the flexible hinge is adjustably connected to the adjacent mats.

17. The method as defined in claim 15 wherein the flexible hinge is adjustably connected to the adjacent mats.

18. The method as defined in claim 14 wherein the first connectors comprise a strip on each mat, each strip having a first width.

19. The method as defined in claim 18 wherein the flexible hinge is of a second width greater than the sum of the widths of the strips.
